(19) United States
(12) Patent Application Publication
(10) Pub. No.: US 2006/0101170 A1
(43) Pub. Date: May 11, 2006

(54) Control method for changing input-output object

(76) Inventors: Masamichi Okajima, Yokohama (JP); Hiroshi Suzuki, Yokohama (JP); Masaru Satou, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/033,376

(22) Filed: Jan. 12, 2005

(30) Foreign Application Priority Data
Nov. 10, 2004 (JP) 2004-325815

(51) Int. Cl. G06F 3/06

(52) U.S. Cl. 710/36

(57) ABSTRACT

A control method for changing an input/output object includes the steps of determining, by an input/output object changing unit on a disk control device for processing an input/output issued by an application program to a logical volume, whether or not change of the input/output object is performed on the basis of identification information of a computer as an input/output issued source having been added to control information and the input/output; performing the input/output by an input-output execution control unit after changing the input/output object from the logical volume into a replica volume of the logical volume if the change is required; and after performing the input/output, reporting an executed result to the application program after restoring the logical volume targeted for the input/output to the logical volume if the change of the targeted logical volume has been performed.

### INCORPORATION BY REFERENCE

The present application claims priority from Japanese application JP2004-325815 filed on Nov. 10, 2004, the content of which is hereby incorporated by reference into this application.

### BACKGROUND OF THE INVENTION

The present invention relates to a technology for changing an input/output object between a disk device and a computer system.

With an increase in the size of the computer system, an increase in the amount of processing data, and extension of service times for online operations in recent years, the time required for backup processing has also increased. As a result, it has become essential that a batch operation such as backup can be executed during execution of the online operation. As an example of the method of fulfilling this purpose, there is a method disclosed in JP-A-11-327986.

### SUMMARY OF THE INVENTION

In the method disclosed in JP-A-11-327986, in order to execute the batch operation such as backup during execution of the online operation, it is necessary to change for each computer the input/output control program of the computer on which an application is run. However, since implementation of the input/output control program differs for each platform, implementation of the input/output control program for various platforms becomes complicated.

An object of the present invention is therefore to provide a control method for changing an input/output object that implements a change of a logical volume targeted by an input/output request without changing the input/output control program of a computer.

In order to achieve the above-mentioned object, in the present invention, change information is stored in a disk control device provided between the computer and a disk drive device in a computer system. Then, for a logical volume to be changed, a correspondence relationship between a change destination volume (the replica volume of the logical volume), to which an input/output object is changed, and a computer to which the change of the input/output object is applied is set in advance in the change information.

When receiving an input/output, the disk control device identifies the computer which has issued the input/output, using the identifier for the computer added to the input/output. If the computer is registered in the change information, the disk control device changes the input/output object to the change destination volume registered in the change information.

When a batch processing request is made from a second computer to a logical volume during execution of online processing by a first computer using the same logical volume, the disk control device of the present invention changes the input/output object of the second computer to the change destination volume or the replica volume of the logical volume.

The present invention can also be applied to an input-output path switching device provided between the computer and the disk control device.

According to the present invention, the disk control device or the input-output path switching device changes a logical volume targeted for access from the computer to the change destination volume of the logical volume. Thus, a batch operation such as backup can be executed during execution of an online operation even if the input/output control program of the computer is not changed.

Other objects, features and advantages of the invention will become apparent from the following description of the embodiments of the invention taken in conjunction with the accompanying drawings.

### BRIEF DESCRIPTION OF THE DRAWINGS

FIG. 1 is an example of a diagram showing a configuration of a computer system for carrying out the present invention;

FIG. 2 is a diagram showing details of definition information and change control information in FIG. 1;

FIG. 3 is a configuration table showing details of change command information in FIG. 2;

FIG. 4 is a configuration table showing details of change group information in FIG. 2;

FIG. 5 is a configuration table showing details of change information in FIG. 2;

FIG. 6 is a configuration table showing details of computer identification information in FIG. 2;

FIG. 7 is a flowchart showing a flow of control by an input-output receiving unit included in an input/output object changing program in FIG. 1;

FIG. 8 is a flowchart showing a flow of control by a definition receiving unit included in the input/output object changing program in FIG. 1;

FIG. 9 is a flowchart showing a flow of control by an input/output object changing unit included in the input/output object changing program in FIG. 1;

FIG. 10 is a configuration diagram showing a flow of data in a schedule executing unit included in the input/output object changing program in FIG. 1;

FIG. 11 is a configuration table showing details of schedule information in FIG. 2;

FIG. 12 is a flowchart showing a flow of control by the schedule executing unit included in the input/output object changing program in FIG. 1;

FIG. 13 shows an embodiment of an operation in which an online operation and a batch operation are performed simultaneously;

FIG. 14 is a diagram for comparing operations of performing batch processing during execution of online processing in a conventional system and the system according to the embodiment of the present invention;

FIG. 15 includes diagrams comparing an operation of changing an object volume in a disk drive device between a conventional art and the embodiment of the present invention;

FIG. 16 is a diagram showing a configuration of a system that changes an input/output object using an input-output path switching device; and

FIG. 17 is a diagram showing correspondence relationships between logical volumes and computers shown in FIG. 5.

### DETAILED DESCRIPTION OF THE EMBODIMENTS

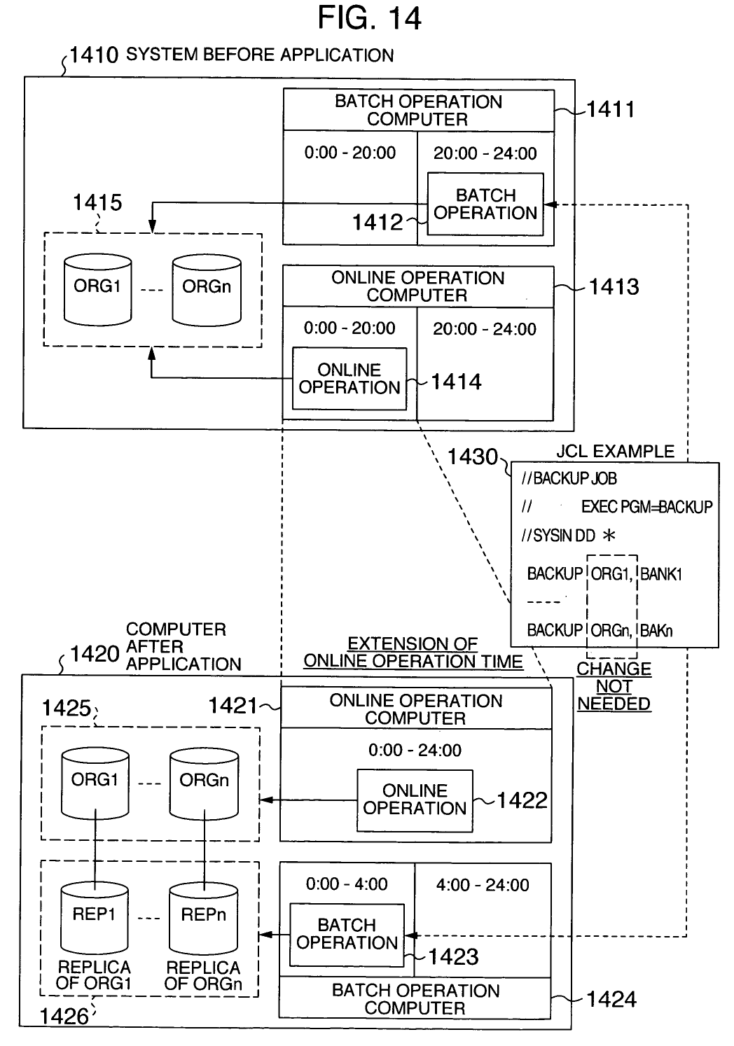

First, referring to FIG. 14, an operation of a conventional system and an operation of a system in an example of an embodiment of the present invention when a batch processing is performed during execution of online processing are compared.

In a system 1410 before the embodiment of the present invention is applied thereto, replica volumes for a logical volume group 1415 to be referenced and updated in an online operation 1414 of an online operation computer 1413 are not present. Thus, after the online operation 1414 has been stopped, a batch operation 1412 of a batch operation computer 1411 had to be started.

On contrast therewith, in a system 1420 after the embodiment of the present invention has been applied thereto, a replica volume group 1426 for a logical volume group 1425 to be referenced and updated in an online operation 1422 of an online operation computer 1421 is present. Thus, by commanding inputs and outputs to the logical volume group 1425 from a batch operation computer 1424 to be changed to inputs and outputs to the replica volume group 1426, the online operation 1422 and a batch operation 1423 can be performed simultaneously. With this arrangement, in the system 1420 to which this embodiment has been applied, the need for stopping the online operation 1422 due to execution of the batch operation 1423 is eliminated. Thus, the operation time of the online operation 1422 can be extended more than in the system 1410 before this embodiment is applied thereto.

Further, a disk control device changes an input/output object. Thus, a JCL example 1430 used in the batch operation 1412 in the system 1410 before this embodiment has been applied thereto can be used without alteration for the batch operation 1423 of the system 1420 to which this embodiment has been applied. Since a plurality of JCLs used for the batch operation is present, in a large-scale system with the great number of the logical volumes, the number of logical volumes specified by the JCLs is greatly increased. Thus, by application of this embodiment, a transitional work for extension of the time of the online operation can be greatly reduced. Unless this embodiment is applied, modification of a vast volume of the JCLs needs to be performed.

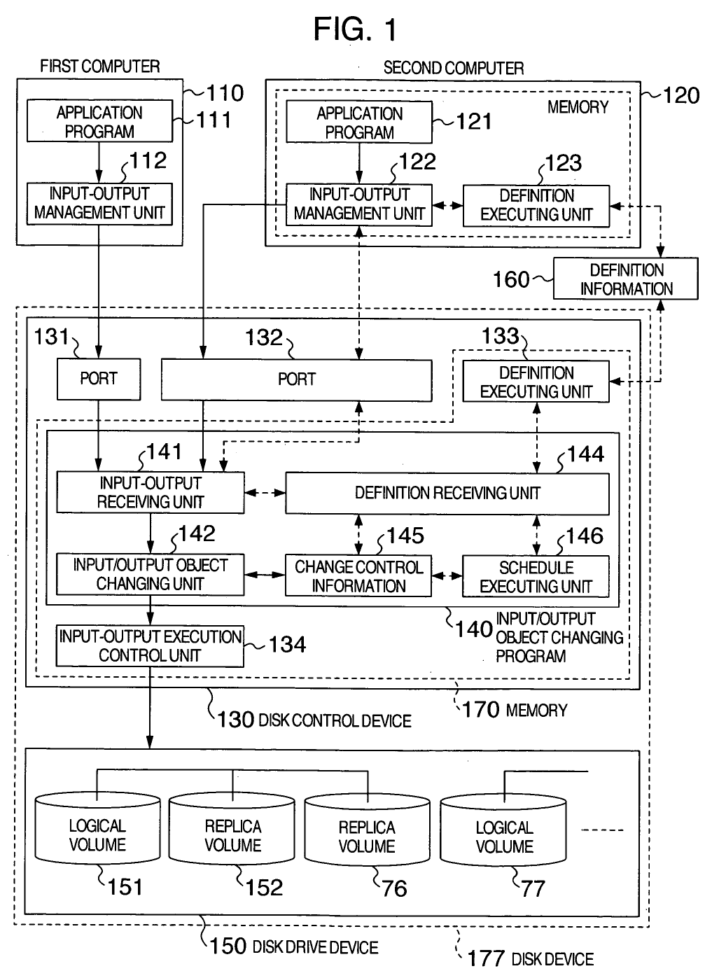

FIG. 1 is an example of a diagram showing a configuration of a computer system according to the embodiment of the present invention. An input/output flow from the computer system to a disk device will be described with reference to FIG. 1. In the drawing, a solid-line arrow indicates a flow of an input/output to a logical volume, while a broken-line arrow indicates a flow of definition information. Definition information 160 is input through an input device connected to a computer, and then transferred to a disk device 177 constituted from a disk control device 130 and a disk drive device 150. The definition information 160 can also be set by the management program of the computer system, or can also be set by reading from a database.

In the computer system shown in FIG. 1, a first computer 110 and a second computer 120 are connected to the disk device 177. The first computer 110 and the second computer 120 are connected to the disk control device 130 directly or through a network.

In a memory 170 of the disk control device 130, a definition executing unit 133, an input-output execution control unit 134, and an input/output object changing program 140 are stored.

An input/output issued from an application program 111 run on the computer 110 to a logical volume 151 is transferred to the disk device 177 through a port 131 connecting an input-output management unit 112 provided by an operating system or the like and the disk device 177. A connecting region between each computer and the disk device 177 is referred to as a port, which generally includes the one referred to as a channel in a mainframe as well. The disk device 177 is constituted from the disk control device 130 and the disk drive device 150. The input/output from the computer is transferred to the input/output object changing program 140 through the port 131 connected to the port of the computer. The input/output is first processed by an input-output receiving unit 141. The input-output receiving unit 141 determines whether the input/output transferred to the disk device 177 is the one for the logical volume or the definition information according to the content of the data of the input/output transferred to the disk device 177. If the input/output is the one for the logical volume, the input-output receiving unit 141 passes the content of the data to the input/output object changing unit 142. On the other hand, if the input/output is the one for the definition information, the input-output receiving unit 141 passes the content of the data to a definition receiving unit 144. If the data of the transferred input/output is the input/output for the definition information, information to be included in the definition information is stored in various tables included in change control information 145 of the input/output object changing program 140, and referenced during execution of the input/output object changing program 140.

The input/output object changing unit 142, which has received the input/output for the logical volume, determines whether to change identification information of the logical volume targeted for the input/output or not, based on identification information of the computer that has issued the input/output, added to the input/output and information that can be obtained from the change control information 145.

When the input/output object changing unit 142 has determined to change the identification information, the input/output object changing unit 142 changes the logical volume targeted for the input/output from the logical volume 151 to a replica volume 152 that has duplicated the content of the logical volume 151 using the function of the disk control device of creating a replica volume, and passes the input/output to the input-output execution control unit 134.

When the input/output object changing unit 142 has determined not to change the identification information, the input/output object changing unit 142 does not perform the change of the logical volume targeted for the input/output, and passes the input/output to the input-output execution control unit 134.

The input-output execution control unit 134 executes the input/output to the specified logical volume, which is the replica volume 152 when the input/output object changing unit 142 has performed the change, or the logical volume 151 when the input/output object changing unit 142 has not performed the change. Then, the input-output execution control unit 134 returns the result of the execution to the input/output object changing unit 142.

The input/output object changing unit 142, which has received the result of the execution, changes the logical volume targeted for the input/output back to the logical volume 151 when the input/output object changing unit 142 has received the request for the input/output from the input-output receiving unit 141 and returns the result of the execution to the input-output receiving unit 141. When the input/output object changing unit 142 has not performed the change of the logical volume targeted for the input/output, the input/output object changing unit 142 returns the result of the execution received from the input-output execution control unit 134 to the input-output receiving unit 141 without alteration.

The input-output receiving unit 141, which has received the result of the execution, reports the result of the execution to the input-output management unit 112 through the port 131.

The change control information 145 to be referenced by the input/output object changing unit 142 is set by inputting the content of the definition information 160 to the definition executing unit 133 on the disk control device 130. Alternatively, the change control information 145 can be set as a type of an input/output through an input-output management unit 122 and a port 132, by a definition executing unit 123 on the computer 120. An input/output requested by an application program 121 is transferred to the disk device 177 through the port 132. The definition information 160 is transferred to the port 132 from the definition executing unit 123 as a type of the input/output. Then, the input/output is determined to be the definition information by the input-output receiving unit 141, and input to the definition receiving unit 144. Further, the definition information and the date on which the definition information will be reflected on the change control information 145 are specified. Then, on the specified date, a schedule executing unit 146 inputs the definition information to the definition receiving unit 144, thereby enabling automatic setting of the change control information 145.

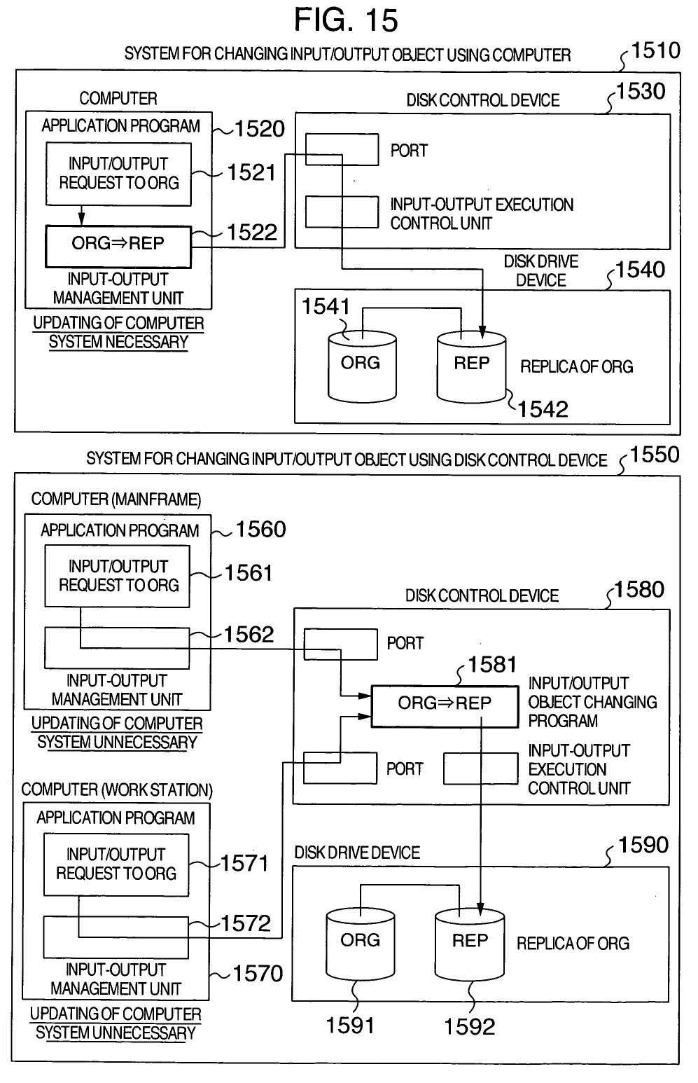

FIG. 15 is a diagram comparing the method of changing a logical volume targeted for input/output in a disk drive device between a system 1510 for changing an input/output object by a computer, such as the system disclosed in JP-A-11-327986, and a system 1550 for changing the input/output object by a disk control device. The system 1550 is the one to which the embodiment shown in FIG. 1 is applied.

In the system 1510 for changing the input/output object by the computer, an input-output management unit 1522 of a computer 1520 changes a logical volume targeted for an input-output request 1521 of an application program from an ORG 1541 of a disk drive device 1540 to a REP 1542, which is the replica of the ORG 1541. Accordingly, it is necessary to invariably update the input-output management unit 1522 of the computer 1520 when the system is introduced. Since the input-output management unit 1522 is one of services provided by an operating system to the application program, it generally becomes necessary to update the operating system in order to update the input-output management unit 1522. When updating the operating system, it sometimes becomes necessary to update the application program. Thus, the burden at the time of the introduction of the system is great.

Further, the internal structure of the input-output management unit 1522 varies from operating system to operating system. Thus, when an input/output function is to be introduced into a system that uses the operating system incapable of changing an input/output object, it is necessary to newly create input/output object changing processing for the operating system. Thus, it takes time to introduce the system.

On the other hand, in the case of the system 1550 for changing an input-output object by the disk control device as in this embodiment, an input/output object changing program 1581 of a disk control device 1580 changes a logical volume targeted for an input-output request 1561 from the application program of a computer 1560 or an input-output request 1571 of the application program of a computer 1570, from an ORG 1591 of a disk drive device 1590 to a REP 1592, which is the replica of the ORG 1591. Thus, modification of an input-output management unit 1562 of the computer 1560 and modification of an input-output management unit 1572 of the computer 1570 are not necessary. For this reason, the system for changing an input-output object by the disk control device can be readily applied to various platforms.

Further, in the conventional system, when an input/output request to a logical volume is made from other computer while a certain computer accesses the same logical volume, a disk control device 1530 performs exclusive control over the logical volume. Thus, a wait time until the request from the other computer is processed is generated. On the other hand, in this embodiment, when an input/output request to a logical volume is made from other computer while a certain computer accesses the same logical volume, the disk control device 1580 changes the input-output object to the replica volume of the logical volume. Thus, the wait time caused by the exclusive control is reduced more than in the conventional system.

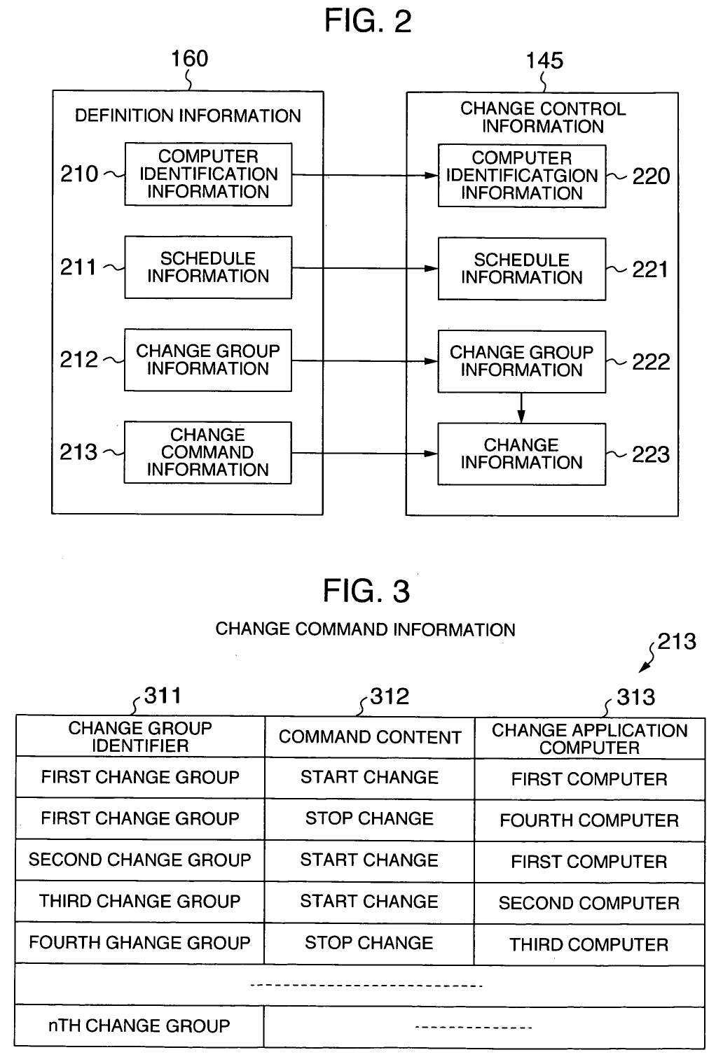

FIG. 2 explains information defined in the definition information 160, information managed in the change control information 145 in the input/output object changing program 140, and the relationship between them.

The definition information 160 is the information defined by a system manager, and includes computer identification information 210, schedule information 211, change group information 212, and change command information 213, and is reflected on the information managed by the change control information 145 by the definition receiving unit 144 through the definition executing unit 123 or the definition executing unit 133.

The computer identification information 210, schedule information 211, and change group information 212 among the definition information 160 are the information set when the system is constructed. The change command information 213 is the information defined when the start and the stop of the change of an input/output object is commanded to the input/output object changing program 140, such as before the start of a batch operation requesting an access to a replica volume and after the completion of the batch operation during an online operation.

The change control information 145 is constituted from computer identification information 220, schedule information 221, change group information 222, and change information 223. In the computer identification information 220, schedule information 221, and change group information 222, the contents of the computer identification information 210, schedule information 211, and change group information 212 of the definition information 160 are set, respectively. The change information 223 is set based on the information in the change command information 213 of the definition information 160 and the change group information 222 of the change control information 145.

In the computer identification information 220, associating information for changing a computer identifier added to an input/output to a computer identifier referenced by the input/output object changing unit 142 is set.

In the schedule information 221, the date of the change of a logical volume and the change command information 213 to be set on that date are set, and are referenced by the schedule executing unit 146 at a certain time interval.

The change group information 222 defines an identifier corresponding to a group of one or a plurality of logical volumes to be changed.

The change information 223 holds information of a status indicating whether to change an input/output object for each computer that has issued an input/output and information on a change destination logical volume. The input/output object changing unit 142 determines whether or not to change the input/output object and changes the input/output object based on these information.

FIG. 3 explains about the change command information 213 of the definition information 160, which is the definition for setting the change information 223. The change command information 213 is constituted from a change group identifier 311, a command content 312, and a change application computer 313.

The change group identifier 311 is the identifier assigned to the group of one or a plurality of logical volumes to be divided. For each change group, collective setting of the change information 223 is performed.

The command content 312 commands the input/output object changing unit 142 to start and stop the change. Since the input/output object changing unit 142 determines whether or not to change an input-output object by referring to the change information 223, the command content 312 is reflected on the change information 223.

The change application computer 313 indicates the identifier associated with each of the computers connected to the disk control device, and sets, for a specified change group, the computer identifier for the computer that has issued an input/output and to which the change of an input/output object is applied.

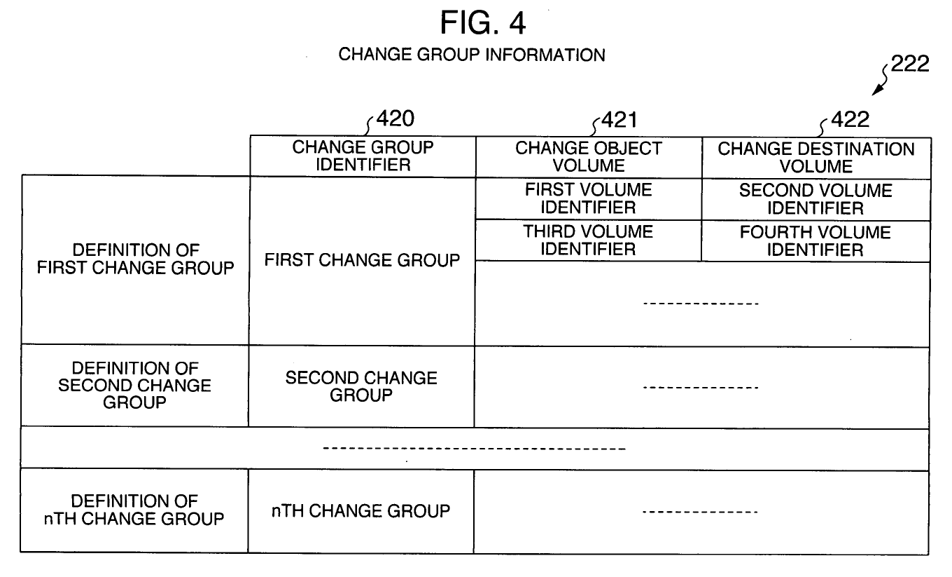

FIG. 4 explains the change group information 222 in the change control information 145.

A change object volume 421 and a change destination volume 422 are defined in a pair for each change group identifier 420 for identifying each change group. The change object volume 421 specifies the volume identifier for a logical volume to be changed, and the change destination volume 422 specifies the volume identifier for a change destination volume associated with the change object volume 421. By grouping one or a plurality of logical volumes targeted for the input/output object change, the start and the stop of the input/output object change can be set for each group.

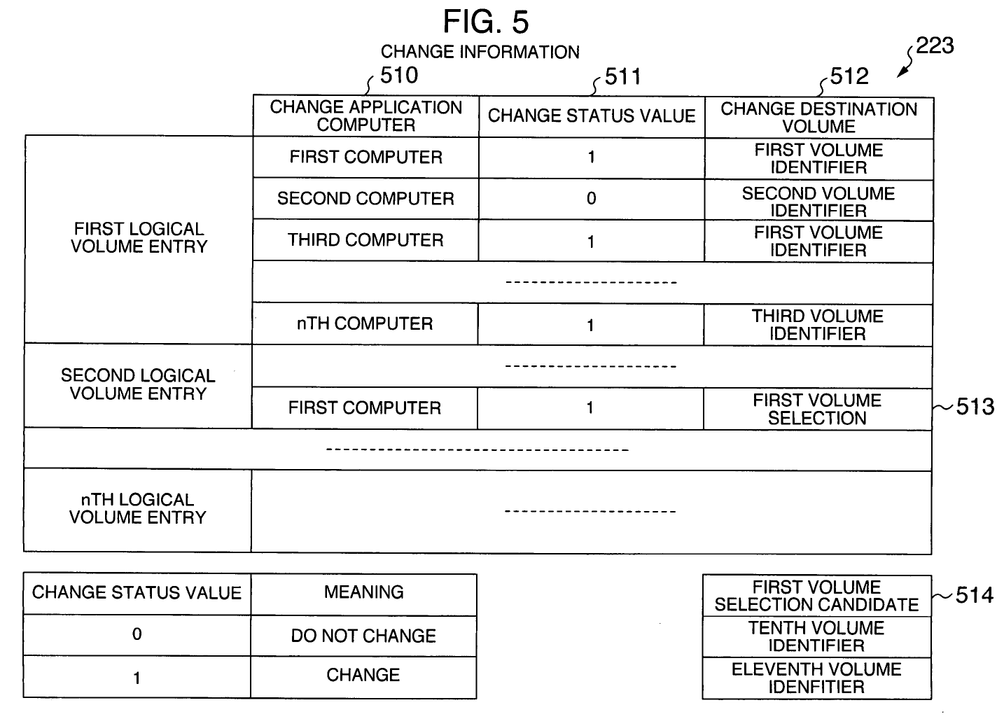

FIG. 5 explains about the change information 223 in the change control information 145. The change information 223 is the information used when the input/output object changing unit 142 determines whether to change an input/output object for each logical volume, and for every logical volume, information of a change application computer 510, a change status value 511, and a change destination volume 512 is held.

The change application computer 510 is the identifier for the computer that has issued an input/output and to which the change of an input/output object should be applied, and is used when the input/output object changing unit 142 determines whether an input/output is from the computer to which the change of an input/output object should be applied. The value of the change application computer 313 in the change command information 213 is set in this computer identifier by the definition executing unit 133.

The change status value 511 is the value indicating a state where the change of an input/output object should be performed or not, and is referred to by the input/output object changing unit 142. When the change status value is “1”, it indicates the state where the change of the input/output object should be performed. When the change status value is “0”, it indicates the state where the change should not be performed. This value is set by the definition executing unit 133, based on the value of the change content 312 of the change command information 213. When the change content 312 indicates the start of the change, “1” is set in the change status value 511. When the change content 312 indicates the stop of the change, “0” is set in the change status value 511. When an access request to a logical volume is made from a computer, the logical volume is accessed if the change status value 511 of the computer is “0”. If the change status value 511 is “1”, the replica volume having the volume identifier indicated in the change destination volume 512 is accessed.

The change destination volume 512 is the identifier for a logical volume targeted for the change of an input/output object. When the input/output object changing unit 142 has determined to change the input/output object, the change destination volume 512 is used as the destination for the input/output object. In this volume identifier, the value of the change destination volume 422 included in the change group information corresponding to the change group identifier of the change command information 213 is set by the definition executing unit 133.

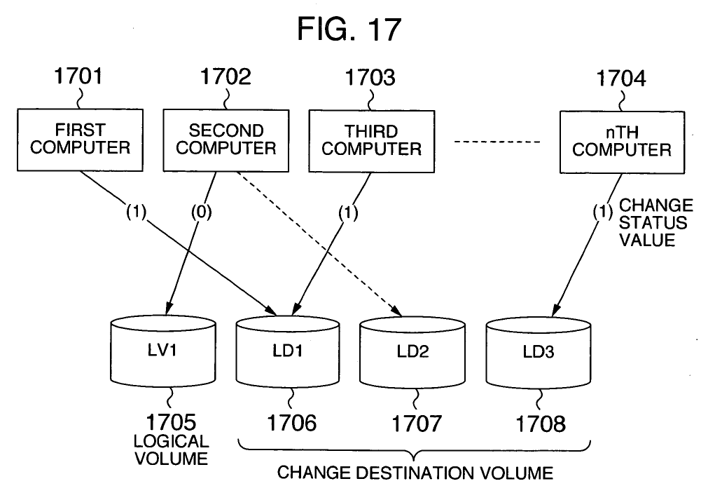

As shown in FIG. 17, a first logical volume entry in FIG. 5 indicates that a first logical volume (LV1, 1705) having a second volume identifier is assigned to a second computer 1702, a replica volume (ID1, 1706) having a first volume identifier is assigned to a first computer 1701 and a third computer 1703, and a replica volume (ID3, 1708) having a third volume identifier is assigned to an nth computer 1704. The first logical volume entry also indicates that when the second computer 1702 cannot use the first logical volume (LV1, 1705), the volume to be accessed is changed to a replica volume (ID2, 1707) having the second volume identifier, indicated by a broken line in FIG. 17. FIG. 17 further indicates that in the correspondence relationship between the second computer 1702 and the logical volume 1705, the change status value 511 is “0”, and that in each of the correspondence relationships between the first computer 1701 and the replica volume 1706, between the third computer 1703 and the replica volume 1706, and between the nth computer 1704 and the replica volume 1708, the change status value 511 is “1”.

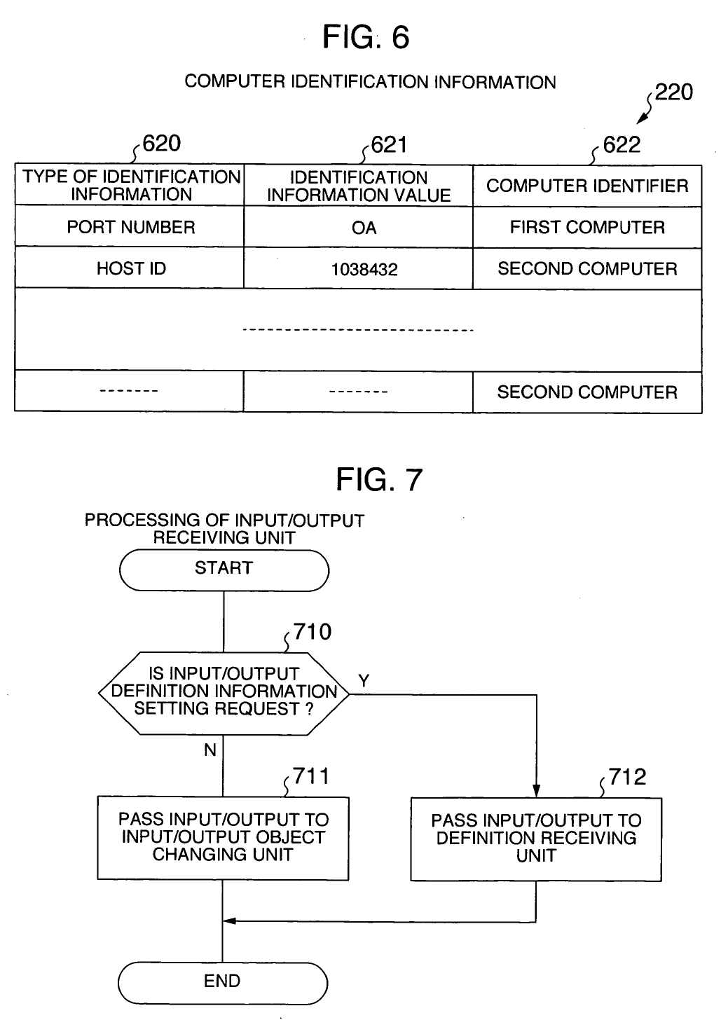

FIG. 6 explains the computer identification information 220 in the change control information 145, which holds an identification information type 620, an identification information value 621, and a computer identifier 622.

The identification information value 621 indicates physical identification information uniquely identifying a computer connected to the disk device, such as a path group identifier used in a mainframe and a world-wide name used in a storage area network. When the identification information cannot be obtained from a computer, the address of the port 131 of the disk device or the like can also be used.

The identification information type 620 indicates which type of the identification information described above the identification information value 621 belongs to.

The computer identifier 622 is the identifier used in the change information 223 so as to uniquely identify the computer, and is associated with the identification information value 621 by the computer identification information 210 in a one-to-one correspondence.

FIG. 7 is a flowchart showing a flow of control by the input-output receiving unit 141. An input/output from the computer 110 or the computer 120 is received by the input-output receiving unit 141 through the port 131 or 132 of the disk control device 130. The input-output receiving unit 141 determines the type of the input/output at step 710. If the input/output is a request for setting the change control information 145, the input-output receiving unit 141 passes the input/output to the definition receiving unit 144 at step 712.

If the input/output is the request for reading from or writing to the replica volume 152, the input-output receiving unit 141 passes the input/output to the input/output object changing unit 142 at step 711.

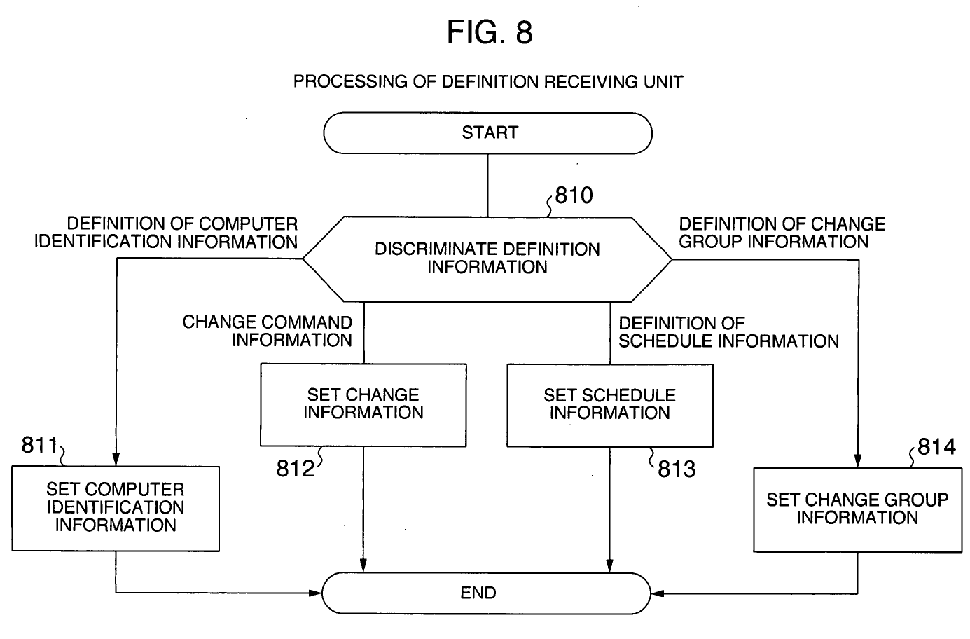

FIG. 8 is a flowchart showing a flow of control by the definition receiving unit 144. The definition receiving unit 144 determines which information in the change control information 145 the received definition information 160 defines, at step 810. If the definition information is the definition of the computer identification information 210, the definition receiving unit 144 sets the computer identification information 220 at step 811. If the definition information is the change command information 213, the definition receiving unit 144 sets the change information 223 at step 812. If the definition information is the definition of the schedule information 211, the definition receiving unit 144 sets the schedule information 211 at step 813. If the definition information is the definition of the change group information 212, the definition receiving unit 144 sets the change group information 212 at step 814.

While the change command information 213 sets the change content 312 and the change application computer 313 for each change group, the change information 223 manages the change status value 511, change application computer 510, and change destination volume 512 for each logical volume. Thus, the change command information 213 and the change information 223 differ in table structures thereof. Thus, for every the change object volume 421 registered in the entries of the change group identifier 420 in the change group information 222 which has the same value as the change group identifier 311 in the change command information 213, the change information 223 is set, at step 812.

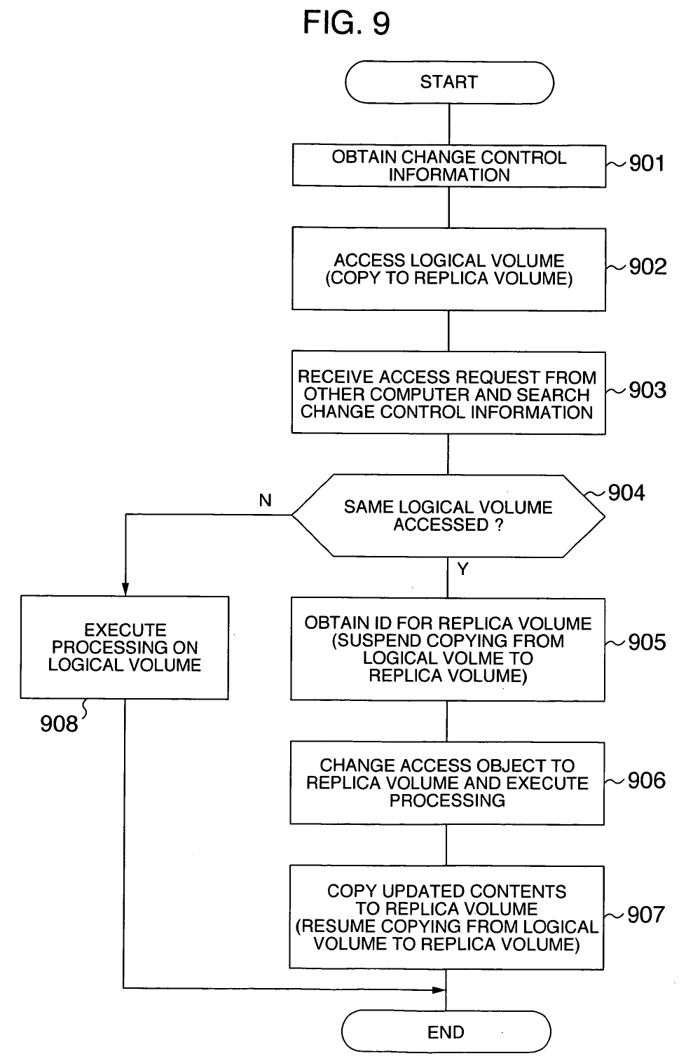

FIG. 9 is a flowchart showing a flow of control by the input/output object changing unit 142 shown in FIG. 1. A case where during online processing of a logical volume, batch processing is performed on the same logical volume, as shown in FIG. 14, will be described below.

When an access request for the online processing is made from a computer (such as the first computer 110) to the logical volume 151, the input/output object changing unit 142 inputs the definition information 160 defining the correspondence relationships between the computers, the logical volumes, and the replica volumes of the logical volumes to obtain the change control information 145 stored in the disk control device 130, at step 901.

The correspondence relationship between the first computer 110 and the logical volume 151 is registered in the change information 223 included in the change control information 145 and shown in FIG. 5. If the change status value 511 is “0”, the logical volume 151 is assigned to the first computer, so that processing associated with the access request is performed. Then, during execution of the processing, data stored in the logical volume 151 is copied to the replica volume 152 at step 902.

When an access request (for batch processing) to a logical volume is received from other computer such as the second computer 120 during accessing to the logical volume 151 by the first computer 110, the input/output object changing unit 142 searches the change information 223 included in the change control information 145 at step 903 to check whether the logical volume to which the second computer 120 has made the access request is the same as the logical volume being accessed by the first computer 110 at step 904.

When the access request is made to the same logical volume 151 and the change status value 511 of the second computer 120 is “1”, the input/output object changing unit 142 refers to the change destination volume 512 in the change information 223 to obtain the identifier for the change destination volume 512, or the replica volume 152 in this case. Further, at the instant when consistency of the online processing has been checked, the input/output object changing unit 142 suspends the copying operation of data from the logical volume 151 to the change destination volume 512 (replica volume 152), and disconnects the replica volume 152 from the access object of the first computer 110, at step 905.

Then, the input/output object changing unit 142 causes the processing on the logical volume 151 to be continued, and also changes the access object in the access request from the second computer 120 from the logical volume 151 to the replica volume 152, which is the change destination volume 512, and causes the processing requested by the second computer 120 to be executed at step 906.

After the processing requested by the second computer 120 has been completed, the updated content of the logical volume 151 updated by the access request from the first computer 110 during suspension of the copying operation at step 905 is copied to the replica volume 152. Processing for matching the contents of the replica volume 152 with the contents of the logical volume 151 is thereby performed. Then, the input/output object changing unit 142 causes the copying operation from the logical volume 151 to the replica volume 152, performed at step 902 to be resumed, at step 907.

At step 904, if it has been found that the logical volume to which the second computer 120 has made access request is not the same as the logical volume being accessed by the first computer 110, the logical volume targeted for the access request object is assigned to the second computer 120, so that processing associated with the access request is executed at step 908.

Control by the input/output object changing unit 142 shown in FIG. 9 is applied when an access request for data output (or data reading) has been made to the logical volume 151 during execution of another data input or output to the same logical volume 151. When data backup processing (batch processing) on a logical volume is performed during execution of the online processing of the same logical volume, for example, this embodiment can be applied.

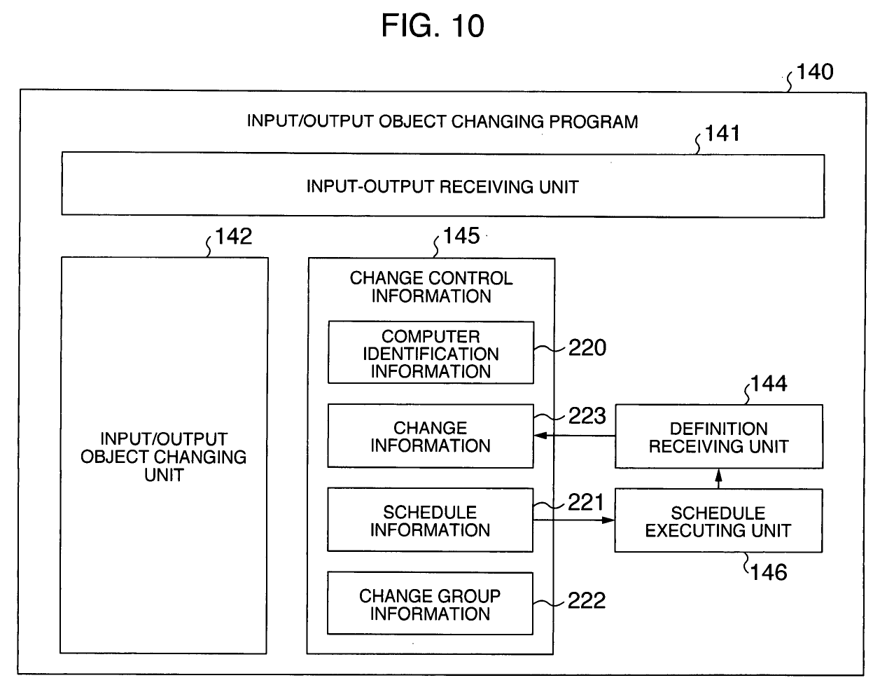

FIG. 10 shows a flow of information about execution of a schedule set in the change information 223 using solid lines. The schedule executing unit 146 operates at a certain time interval. When the date and time defined in the schedule information 221 matches the current time, the schedule executing unit 146 passes the change command information 213 registered in the schedule information 221 to the definition receiving unit 144. The definition receiving unit 144, which has received the change command information 213, sets the change information 223 based on the change command information 213.

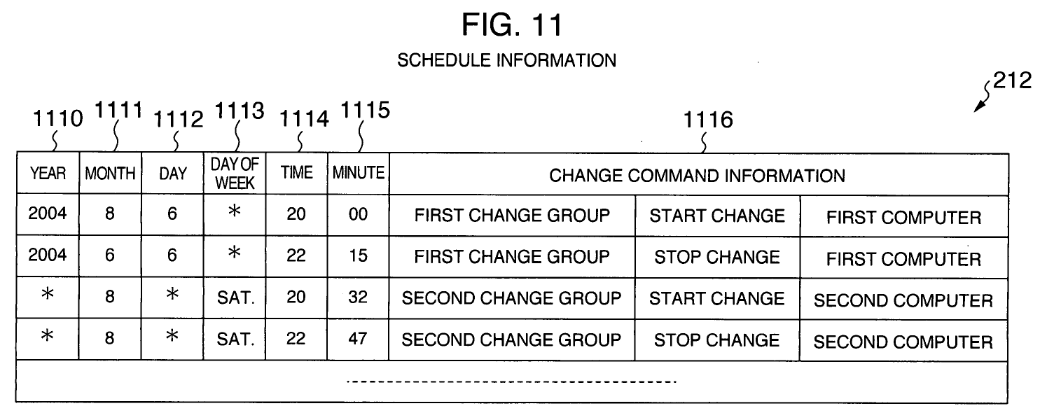

FIG. 11 explains about the schedule information 221. The schedule information 221 holds information of a year 1110, a month 1111, a day 1112, a day of week 1113, a time 1114, a minute 1115, and change command information 1116. The date and time when a system manager reflects the change command information 1116 on the change information 223 are set in the year 1110, month 1111, day 1112, day of week 1113, time 1114, and minute 1115. A symbol “*” can be specified in the year 1110, month 1111, day 1112, day of week 1113, time 1114, and minute 1115, and an item with the symbol “*” specified therein is excluded from determination performed by the schedule executing unit 146 as to whether the date and time defined in the schedule information 221 matches the current time. Accordingly, when the symbol “*” is set in the year 1110, month 1111, and day 1112, when “Saturday” is set in the day of week 1113, “20” is set in the time 1114, and when “0” is set in the minute 1115, for example, it means that the change command information 1116 is passed to the definition receiving unit 144 by the schedule executing unit 146 at 20:00 every Saturday, and that the change information 223 is changed based on the change command information 1116.

Incidentally, the items set in the change command information 1116 of the schedule information 221 are the same as the change command information 213.

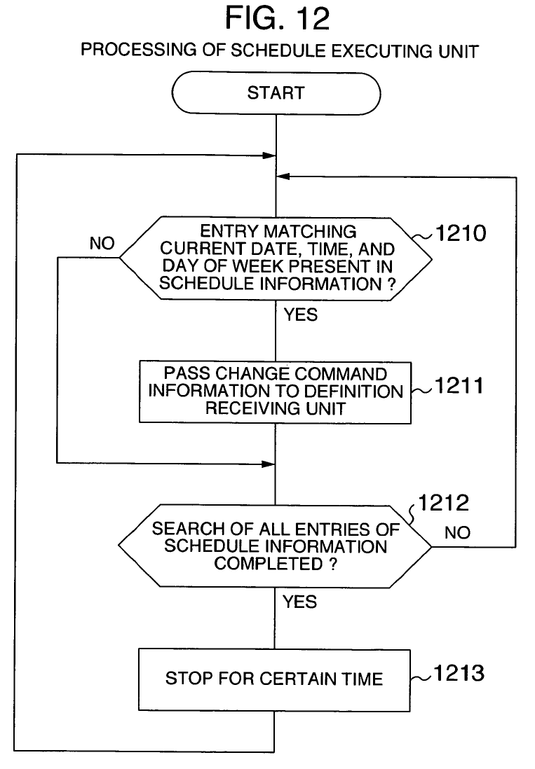

FIG. 12 is a flowchart showing a flow of control by the schedule executing unit 146. The schedule executing unit 146 searches whether there is an entry in the schedule information 221 matching the current year, month, day, day of week, time, and minute, at step 1210. When determination of a match with the current date and time is performed, an item with the symbol “*” specified therein is not targeted for the determination.

When a matching entry has been detected as a result of the search, the schedule executing unit 146 passes the change command information 1116 on that entry to the definition receiving unit 144, at step 1211. This processing is performed on all the entries of the schedule information 221 that match the current date and time, at steps 1210 to 1212.

After the above-mentioned processing has been completed, the schedule executing unit 146 resumes the determination of a match with the current date and time after the stop of a certain time at step 1213.

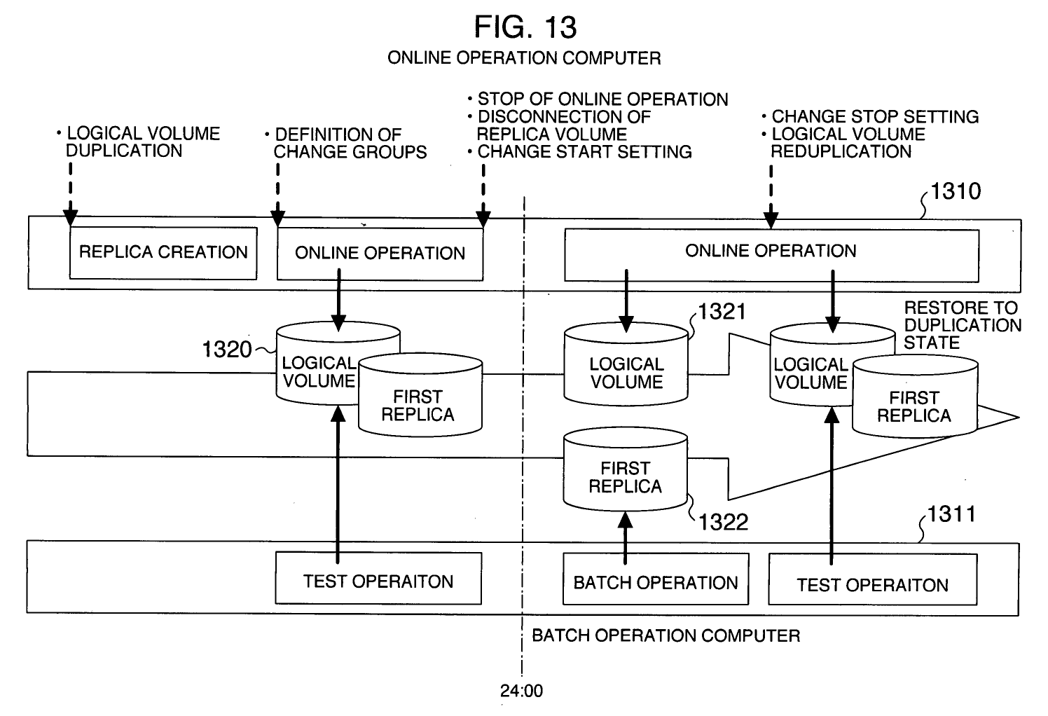

FIG. 13 shows the embodiment in a case where an online operation and a batch operation are simultaneously performed by two computers according to the schedule described with reference to FIGS. 11 and 12. Before the online operation is started, commanding to create the replicas of the logical volumes 1320, 1321 using the function of the disk control device of creating the replicas, definition of the computer identification information, and definition of the change group information are performed by an online operation computer 1310, as preliminary preparations. Then, the online operation is started.

When it becomes 24:00, the backup of a logical volume 1321 on that day to be used for the online operation is taken. First, as a preparation to simultaneously execute the online operation and the batch operation or backing up, the online operation is temporarily stopped to ensure consistency of transaction data. Next, in order to ensure that the contents of a replica volume 1322 are the contents at 24:00, connection between the logical volume 1321 and the replica volume 1322 is temporarily stopped using the function of the disk control device of creating the replica of a logical volume. In this state, updating of the logical volume 1321 is not reflected on the replica volume 1322. Next, change start setting for changing the input/output object of a batch operation computer to the replica volume is performed. Thereafter, the online operation is resumed, and the batch operation by the batch operation computer 1311 is started. Since the change start setting has been performed, an input/output from the online operation computer 1310 is performed to the logical volume 1321, while an input/output from the batch operation computer 1311 is performed to the replica volume 1322 having the contents as of 24:00.

When the batch operation has been completed, change stop setting and reconnection between the logical volume 1321 and the replica volume 1322 are commanded. Then, with the contents of the logical volume 1321 matched with the contents of the replica volume 1322, the online operation is continued.

In the embodiment described above, only one change destination volume stored in the change information 223 shown in FIG. 5 was employed for each computer. However, among a plurality of change destination volume candidates prepared in advance, unused replica volumes can also be selected as the change destination volumes. As shown in a row 513 for a second logical volume entry in the change information 223 shown in FIG. 5, “first volume selection”, which is the information indicating selection of a volume, is stored in the field of the change destination volume 512 in place of the volume identifier, and a volume selection candidate table 514 associated with this information is referred to. Then, unused replica volumes are selected from among volume selection candidates in the volume selection candidate table 514. The row 513 shown in FIG. 5 indicates that when the first computer uses the second logical volume, two replica volumes with the volume identifiers 10 and 11 are prepared as the change destination volumes of the second logical volume. Incidentally, whether the logical volume or the replica volume is already being used can be determined based on the locked states of the volumes, or the statuses during execution of input/outputs to the volumes.

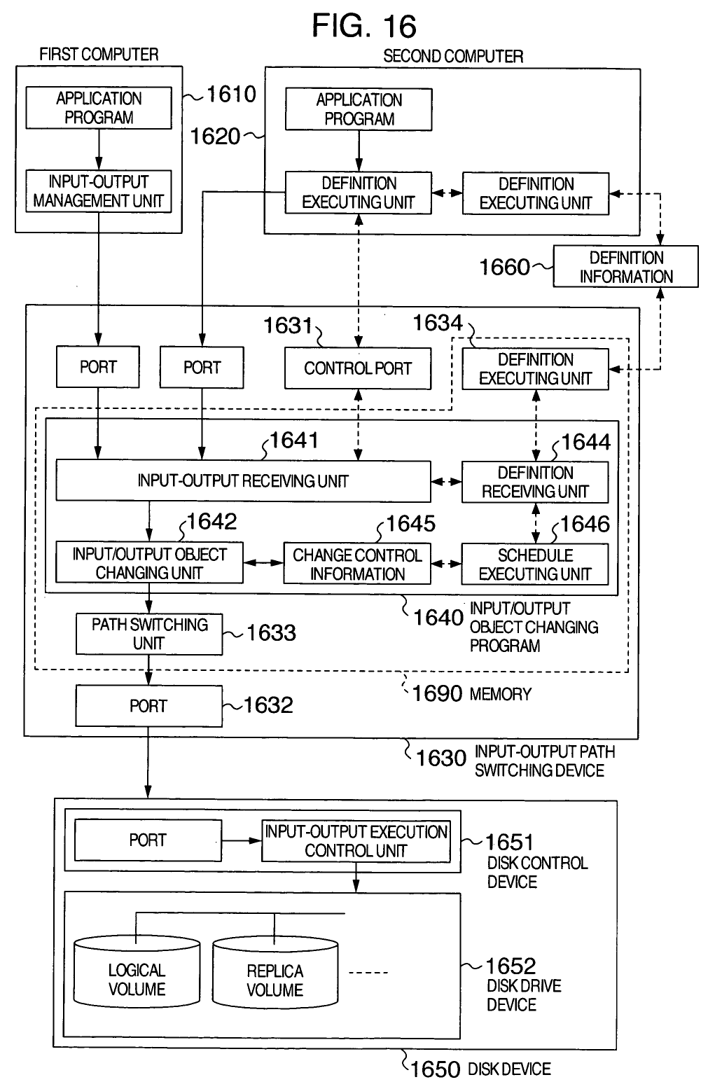

FIG. 16 is a diagram showing a configuration of a system for changing an input/output object using an input-output path switching device 1630 in this embodiment. The input-output path switching device 1630 includes the ones referred to as a director, a switch, and the like. The input-output path switching device 1630 has the same configuration as the disk control device 130 shown in FIG. 1 except for the following respects: In addition to the ordinary ports for performing input and output of data, a control port 1631 is provided for the input-output path switching device 1630, and processing performed by the input-output execution control unit 134 in FIG. 1 is performed by a path switching unit 1633 in FIG. 16.

An input/output object changing program 1640 of the input-output path switching device 1630 in FIG. 16 is constituted from an input-output receiving unit 1641, an input/output object changing unit 1642, a definition receiving unit 1644, change control information 1645, and a schedule executing unit 1646. These are the same as the components constituting the input/output object changing program 140 in the disk control device 130 in FIG. 1. Further, definition information 1660 and a definition executing unit 1634 of the input-output path switching device are also the same as the definition information 160 and the definition executing unit 133 of the disk control device 130 in FIG. 1, respectively.

Solid line arrows in FIG. 16 indicate flows of inputs/outputs targeted for the logical volumes, while broken line arrows indicate flows of the definition information.

An input/output issued from a computer is received by the input-output receiving unit 1641 of the input-output path switching device 1630. Then, after the change of an input-output object has been performed by the input/output object changing unit 1642 as by the input/output object changing program 140 in the disk control device 130 in FIG. 1, the input/output is passed to a port 1632 connected to the a disk device 1650 in which a logical volume targeted for the input/output, changed by the path switching unit 1633 is present.

Setting of the change control information 1645 referred to by the input/output object changing unit 1642 can be performed by inputting the content of the definition information 1660 to the definition executing unit 1634 on the input-output path switching device 1630. Further, by passing through the control port 1631, the definition information 1660 can be set in the change control information 1645 as a type of an input/output from a computer 1620.

The definition executing unit 1634, path switching unit 1633, and input/output object changing program 1640 are stored in a memory 1690 of the input-output path switching device 1630.

Referring to FIG. 16, a case where the application program of the second computer 1620 executes a batch operation such as backup while the application program of a first computer 1610 executes on-line operation service using data stored in a logical volume will be considered. Though the replica data of a logical volume is stored in a replica volume, data in the logical volume is used for ordinary processing, which is an online operation in this case. Unless otherwise specified, the same logical volume is used in a batch operation as well. However, the same logical volume being in use in the online operation cannot be accessed for the batch operation. In this embodiment, a replica volume is registered in the definition information 1660 as the change destination volume of the second computer 1620. Then, the definition information is captured by the input-output path switching device 1630, and the input/output object of the second computer is changed to the replica volume, which is the change destination volume. As a result, even while the first computer executes the online operation using a logical volume, the second computer can perform the batch operation using the replica volume of the logical volume. Thus, there is no need for changing the input-output program of the computer.

A program for executing the method in this embodiment, described above can also be stored in a storage medium that can be input by a computer, and this program can be read into a memory, for execution.

It should be further understood by those skilled in the art that although the foregoing description has been made on embodiments of the invention, the invention is not limited thereto and various changes and modifications may be made without departing from the spirit of the invention and the scope of the appended claims.

1. A control method of a disk control device for changing an input/output object, the disk control device being coupled to a plurality of computers and having a function of creating a replica volume of a logical volume, the method comprising the steps of:
creating change control information defining relationships among logical volumes, replica volumes of the logical volumes and the computers targeted for connection, the logical volumes and the replica volumes being placed in a disk drive device coupled to the disk control device; and
changing an access from a second one of the computers to the logical volume to an access to the replica volume based on the change control operation when an access request to the logical volume is made from the second one of the computers while the first one of the computers uses the logical volume.

2. The control method for changing an input/output object according to claim 1, further comprising the steps of:
suspending an operation of copying data from the logical volume to the replica volume before the access to the logical volume from the second one of the computers is changed to the access to the replica volume; and
completing processing associated with the access request from the second one of the computers and then resuming the copying operation.

3. The control method for changing an input/output object according to claim 1, further comprising the step of:
copying data updated during suspension of a copying operation to the replica volume after completion of processing associated with the access request from the second one of the computers, matching contents of the replica volume with contents of the logical volume, and resuming the copying operation.

4. The control method for changing an input/output object according to claim 1, further comprising the step of:
selecting the replica volume being a change destination volume, from among the replica volumes prepared in advance as replica volume candidates.

5. A control method of a disk control device for changing an input/output object, the disk control device being coupled to a plurality of computers and having a function of creating a replica volume of a logical volume, the method comprising the steps of:
holding change control information defining relationships among logical volumes, replica volumes of the logical volumes and the computers targeted for connection, the logical volumes and the replica volumes being placed in a disk drive device coupled to the disk control device;
determining whether to change the input/output object based on the change control information and computer identification information added to a data input/output, for identifying one of the computers that has issued the data input/output, when the data input/output to the logical volume is requested from a second one of the computers during execution of a data input/output to the logical volume by a first one of the computers;
changing the input/output object from the logical volume to the replica volume of the logical volume and then suspending a copying operation from the logical volume to the replica volume if the change of the input/output object is made;
executing the data input/output to the replica volume;
copying data updated during suspension of the copying operation after execution of the data input/output if the change of the input/output object has been made, matching contents of the replica volume with contents of the logical volume; and
resuming the copying operation.

6. A disk control device coupled to a plurality of computers and having a function of creating a replica volume of a logical volume, comprising:
a storage device holding change control information defining relationships among logical volumes, replica volumes of the logical volumes and the computers targeted for connection, the logical volumes and the replica volumes being placed in a disk drive device;
an input/output object changing unit for determining whether to change an input/output object based on the change control information and information added to an input/output, for identifying one of the computers that has issued the input/output; and
an input-output execution control unit for changing the input/output object from the logical volume to the replica volume of the logical volume and then executing the input/output if the change is made.

7. A storage medium storing a program for implementing the control method for changing an input/output object according to claim 5, the storage medium allowing reading by a computer.
